(19) United States
(12) Patent Application Publication
(10) Pub. No.: US 2022/0104564 A1
(43) Pub. Date: Apr. 7, 2022

(54) Systems, Devices, and/or Methods for Eradicating Viruses

(71) Applicant: PAPYRUS INC., Westerville, OH (US)

(72) Inventors: Ahmed Ibrahim, Westerville, OH (US); Yasir Ibrahim, Westerville, HO (US); Sameh Ibrahim, Westerville, OH (US)

(21) Appl. No.: 17/207,709

(22) Filed: Mar. 21, 2021

Related U.S. Application Data
(60) Provisional application No. 63/087,269, filed on Oct. 4, 2020.

(51) Int. Cl. A41D 13/11; G02F 1/1333

(52) U.S. Cl. CPC A41D 13/1192; G02F 1/133302

(57) ABSTRACT

Certain exemplary embodiments can provide a face mask comprising a liquid crystal sheet and a portion constructed to receive a solution. The solution comprises glycerol and sodium chloride. The liquid crystal sheet is constructed to detect a body temperature of a wearer of the face mask. The liquid crystal sheet is constructed to alert the user if the body temperature if the wearer is above a predetermined threshold.

### CROSS-REFERENCES TO RELATED APPLICATIONS

This application claims priority to, and incorporates by reference herein in its entirety, pending U.S. Provisional Patent Application Ser. No. 63/087,269 (Attorney Docket No. 1479-01), filed Oct. 4, 2020.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a frontal view of an exemplary embodiment of a portion 1000 of a face mask;

FIG. 2A is a diagram of a tetrahedron;

FIG. 2B is a diagram of a cube;

FIG. 2C is a diagram of an octahedron;

FIG. 2D is a diagram of, a dodecahedron;

FIG. 2E is a diagram of a icosahedron;

FIG. 3A is a diagram of a bacteriophage T7;

FIG. 3B is an electron micrograph of bacteriophage T7;

FIG. 3C is a diagram of a vaccinia virus;

FIG. 3D is a diagram of a bacteriophage T4; FIG. 4 is a diagram 4000 of a COVID-19 shaped virus;

FIG. 5A is a diagram 5000 of molecules at a surface of a fluid;

FIG. 5B is a diagram 5500 of density across a fluid surface;

FIG. 6A is a diagram 6000 showing an angle of contact and surface tension for a solid-liquid-gas system;

FIG. 6B is a diagram 6500 of an interface between a virus and glycerol; and

FIG. 7 is a flowchart of an exemplary embodiment of a method 7000.

### DETAILED DESCRIPTION

Certain exemplary embodiments provide a face mask comprising:
a liquid crystal sheet constructed to detect a temperature of a user, the liquid crystal sheet constructed to alert the user if a detected body temperature is above a predetermined threshold; and
a defined portion constructed to receive a solution, the solution comprising glycerol and sodium chloride.

Certain exemplary embodiments can provide a face mask comprising a liquid crystal sheet and a portion constructed to receive a solution. The solution comprises glycerol and sodium chloride. The liquid crystal sheet is constructed to detect a body temperature of a wearer of the face mask. The liquid crystal sheet is constructed to alert the user if the body temperature if the wearer is above a predetermined threshold.

Certain exemplary embodiments provide a method, which can cause a user to spray a mask with a solution, the solution comprising glycerol and sodium chloride.

The inventors hereof strongly believe in contemporary and fundamental science, which can be understood by considering the relation from both micro and macro scales. Because the disclosure presented herein is based upon scientific principles, the efficacy of the systems, devices, and/or methods disclosed herein is objectively unbiased.

The advent of COVID-19 has caused pervasive issues worldwide. Certain exemplary embodiments avoid a danger of remedies to this nagging pandemic being in the hands of strong interest groups or businesses.

Influenza viruses, including COVID-19 are probably the most lethal viruses. They can cause acute respiratory disease. Symptoms can comprise fever, chills, headache, muscle aches, and/or coughs. Influenza viruses affect people of all ages, but can be particularly severe for the very young, the very old, and people with complications due to other maladies. It is estimated that within 18 months during 1918-1919, there were approximately 200 million people infected and approximately 21 million deaths worldwide.

The COVID-19 pandemic has been a severe problem. Certain exemplary embodiments can curtail problems of COVID-19 and other viruses.

Certain exemplary embodiments:
Can be applied to all face mask regardless of color and design;
Are low cost with virtually negligible price and affordable to everyone;
Have no significant side effects;
Are easy to apply;
Can be applied immediately;
Are scientifically sound; and
Do not interfere with washing any face mask due to chemical components being water soluble.

Whether a virus of COVID-19 or of some other type, the method of eradication is the same. COVID-19 is unique in its ability to spread quickly and be highly contagious.

Certain exemplary embodiments provide:
Protection;
Disinfection; and
Detection.

Both protection and disinfection can be looked upon as a two way street during inhaling and exhaling. Absent an active infection, the upper respiratory system will be fairly clean from any viruses that pass through the lungs.

While face masks act as filters to trap viruses and cause some damage, experience has shown that there is no guarantee that they are a panacea to solve the pandemic problem. They can be augmented by the methods outlined in this disclosure during inhaling and exhaling. Certain exemplary embodiments can also detect higher than normal temperature of the human body if a fever occurs.

Any contaminated exhaling air will also pass through the face mask, which can perform an eradication. In other words, certain exemplary embodiments provide a two-way passage protection and could be looked upon as a purifying functioning system. The methods are simple to implement and they are different compared to certain others available to the public.

Certain exemplary embodiments provide a method that comprises spraying an outside surface of the mask. For example, a substantially square area of approximately four square inches can be sprayed with approximately 3 ounces (e.g., from a spray bottle) of a mixture solution of glycerol and sodium chloride on a periodic time interval such as approximately each week. The inventors call the spray “POWER SPRAY”.

Body temperature detection is done by incorporating a thin perforated (e.g., approximately one inch square) liquid crystal sheet at the front side of the mask in a location where inhaling and exhaling take place. The sheet can be suited for any mask, regardless of size or color.

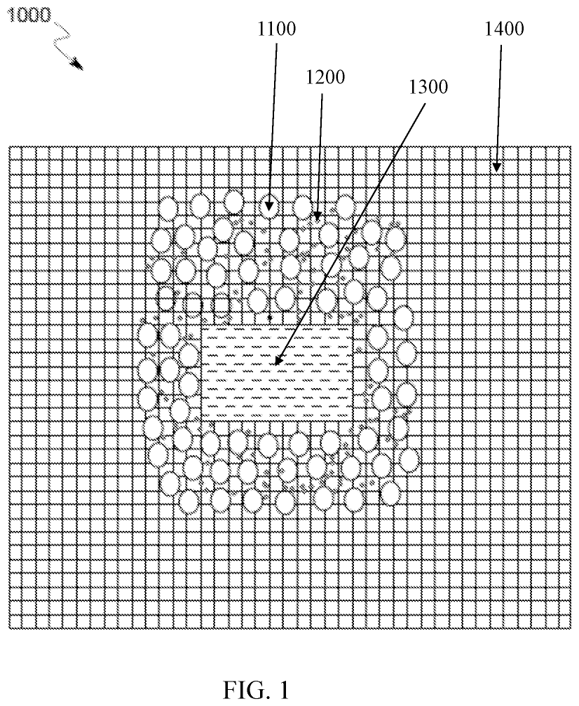

FIG. 1 is a frontal view of an exemplary embodiment of a portion 1000 of a face mask, which comprises a mask fabric 1400. Portion 1000 of a face mask schematically illustrates portion 1000 after having been sprayed with the POWER SPRAY solution, which leaves solution particles 1100. Portion 1000 entraps airborne virus particles 1200, which can contact solution particles 1100 and thereby be eradicated. Portion 1000 is constructed to receive solution particles 1100. The solution particles 1100 can comprise glycerol and sodium chloride. The solution particles 1100 can comprise approximately 80 percent vegetable glycerol solution prepared from a substantially anhydrous product. The solution particles 1100 can comprise approximately 20 grams of edible sodium chloride are added per 100 milliliters of the solution.

Portion 1000 is constructed for body temperature detection via a thin liquid crystal sheet 1300. Liquid crystal sheet 1300 is constructed to detect a body temperature of a wearer of the face mask. Liquid crystal sheet 1300 is constructed to alert the wearer if the body temperature if the wearer is above a predetermined threshold. Liquid crystal sheet 1300 changes color responsive to a change of the body temperature of the wearer.

When exhaled air comes out of a human nose (as determined via body temperature) reaches approximately 37 degrees Celsius (approximately 98.6 degrees Fahrenheit), the liquid crystal sheet sensitivity is designed to change its color from dark blue to yellowish green and beyond as a user temperature varies. Thereby a user is alerted for an abnormality in body temperature and can take immediate action. Perforations in the sheet allow air to seep through the nose.

Both glycerol and sodium chloride are known to have beneficial properties for intercellular and intracellular virus infectivity. This is significant because antibodies are not effective in virus suppression for viruses that cause colds, flu, bronchitis, or runny noses.

Glycerol is known to have a debonding capability for polymers. This is due to the small size of glycerol molecules, which allows them to penetrate between polymer chains and weaken the interaction between the polymer chains. In the case of a virus structure, which can be thought of as a house of cards; once the first link is broken, the whole structure collapses. Debonding takes place due to fundamental surface tension chemistry. The fundamental chemistry involves:
Gibb's free energy;
Interactions described by the first law of thermodynamics; and/or
Interactions described by the Young-Laplace equation.

The underlying chemistry also comprises an osmosis phenomenon, which is exemplified in solvent transport between inside the virus cells and a chemical mixture solution at the outside.

The components of the POWER SPRAY mixture are:
generally regarded as safe by the U.S. Food and Drug Administration (the “FDA”);
non-irritating;
not likely to have any significant adverse effect on the environment;
non-toxic; and
not susceptible to forming ice crystals below the freezing point of water.

In certain exemplary embodiments, the POWER SPRAY mixture comprises approximately 80 percent vegetable glycerol solution prepared from a substantially anhydrous product (e.g., having an approximately 99.5% concentration) diluted with water. For every 100 milliliters of solutions, approximately 20 grams of edible sodium chloride are added.

Both vegetable glycerol and edible sodium chloride are used in food and medicinal applications and are generally regarded as safe by the FDA.

Glycerol can be obtained in a high purity form such as a substantially anhydrous product (e.g., having an approximately 99.5% concentration). Glycerol is also used for soothing and moisturizing creams and lotions, human suppositories, in certain oral and pharmaceuticals for sweetening, as a solvent, and as a food preservative. Glycerol is odorless, colorless, and generally non-irritating to humans. Glycerol is hygroscopic and absorbs moisture from the air. The hygroscopic nature of glycerol can cause a reduction in eyeglass fogging when used on a face mask.

Glycerol can form both intermolecular and intramolecular hydrogen bonds, which allows significant use flexibility. Glycerol can create a bacteriostatic environment, which decreases the number of microbes in wounds and burns when used for treatment. Consequently, glycerol can assist in better healing of wounds and burns. Glycerol can be utilized in foods to maintain freshness and/or provide a low-glycemic sweetness to low fat foods. Glycerol can be utilized as a thickening agent for liqueurs. Glycerol can be utilized in foods such as frosting to prevent hardening. Glycerol can be utilized in electronic cigarettes.

Glycerol has a pH in the 6-7 range and, consequently, is relatively neutral on an acid-base spectrum.

Glycerol can be comprised in bodily cells of humans in glycoproteins, which can be produced upon exposure to a virus (e.g., such as interferon).

Sodium chloride is ubiquitous in application in foods and is an important food preservative. Commercially refined sodium chloride comprises between approximately 97-99% sodium chloride.

Medical scientists are in the process of developing COVID-19 vaccines and treatments. One such vaccine and/or treatment involves a blood plasma injection taken from persons having recovered from infections. Other vaccines are being developed based upon laboratory formulations. At present, results from such treatments might take a long time and are uncertain.

There are distinct differences between airborne viruses and others that are present in human digestive systems (e.g., e-coli, cholera, typhoid, diphtheria, etc.). Viruses present in human digestive systems can be caused from such things as contaminated water or food and can be carried in human cells via absorption.

By contrast influenza viruses generally infect a human respiratory system, such as through a nasal passage. If such viruses are not trapped and eradicated prior to passing an upper respiratory tract, they can migrate to lung cells and do damage resulting in human pulmonary function issues. Problems can be compounded for individuals requiring respirators when such devices are scarce. In such circumstances, it is possible for blood circulation in a human respiratory system to be compromised.

The economic fallout from pandemics like COVID-19 can be significant.

Mathematical models sometimes predict that the rate at which a disease spreads is proportional to a number of people that have contracted the disease and also depends upon a number of people that have not contracted the disease. Certain exemplary embodiments resist viral transmission and spreading of diseases.

Suppose a student carrying a flu virus returns to an isolated college campus of 1,000 students. Further assume that a count of students infected after four days is fifty. According to a certain mathematical model, the count of infected students will increase exponentially as illustrated in Table I.

| Day | Number infected |
|---|---|
| 4 | 50 |
| 5 | 124 |
| 6 | 276 |
| 7 | 507 |
| 8 | 735 |
| 9 | 882 |
| 10 | 953 |

Thus, unless action is taken, viral spread can be rapid.

Certain exemplary embodiments resist viral spread via protection, disinfection, and detection.

In order to have a clear understanding of the mechanism of viral eradication, it is important to understand viral structure. Viral structures can be considered analogous to a crystal form having a small cluster of atoms and molecules with a given shape defined by a count of faces, count of edges, and count of vertices.

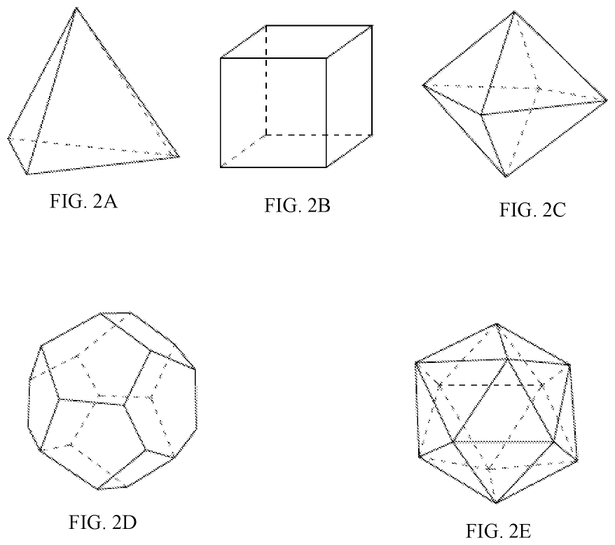

FIG. 2A is a diagram of a tetrahedron.

FIG. 2B is a diagram of a cube.

FIG. 2C is a diagram of an octahedron.

FIG. 2D is a diagram of, a dodecahedron.

FIG. 2E is a diagram of a icosahedron.

With regard to viruses, they belong to four classes or groups, which a filamentous, icosahedral, enveloped, and head and tail.

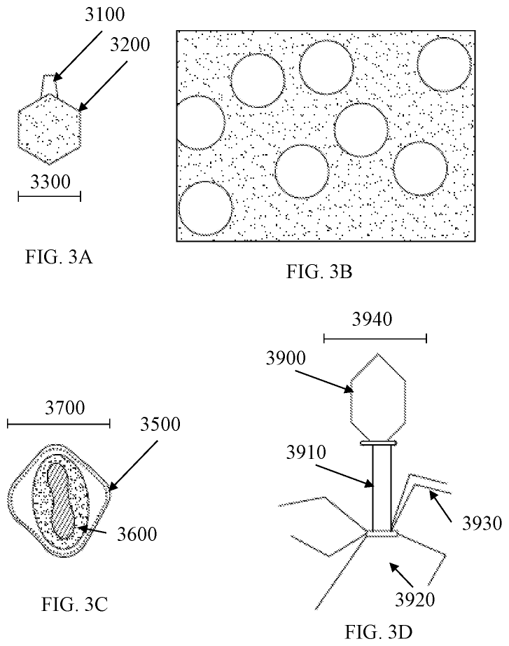

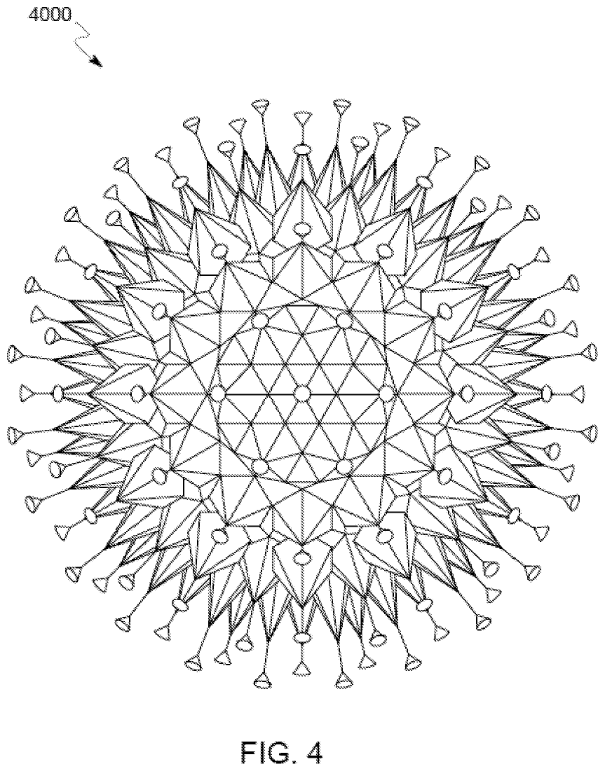

FIG. 3A is a diagram 3000 of a bacteriophage T7, which comprises a head 3100, a tail 3200, and an approximate size 3300 of approximately 100 nanometers.

FIG. 3B is an electron micrograph of bacteriophage T7.

FIG. 3C is a diagram of a vaccinia virus (cowpox), which comprises an envelope 3500, a base plate 3920, a tail fibre 3930, and an approximate size 3700 of approximately 100 nanometers; and

FIG. 3D is a diagram of a bacteriophage T4, which comprises a head 3900, a collar 3910, and an approximate size 3940 of approximately 100 nanometers.

FIG. 4 is a diagram 4000 of a COVID-19 shaped virus.

The icosahedral are known with a spike structure at each of its 12 vertices. An equation attributed to Euler can be used to describe components of a crystal structure:

V−E+F=2 (1)

Where: V=count of vertices;
E=count of edges; and
F=count of faces.

From equation 1, it can be deduced that different combinations result in at least 320,000 species of viruses.

If a viral structure is disrupted by some kind of debonding agent and other means, the ability of the virus to reproduce and infect will be curtailed. Certain exemplary embodiments provide such disruptions.

Viruses cannot grow or replicate on their own and are inert outside of living host cells. Once a virus enters a host cell, it becomes active and can reproduce. As such, viruses can be categorized as between life and nonlife and are not considered living organisms. Viruses are not little cells. Rather, viruses are independent genetic systems capable of transferring itself from one cell to another. Viruses cluster together and can enclose air or gas inside, having a pressure greater than the external pressure. In general, they are much smaller than bacteria, approximately one hundredth in size, ranging in size from approximately 20-400 nanometers in diameter. Viruses comprise a core of nucleic acid, a core of protein called capsid around a nucleic acid core (comprising either DNA or RNA), and in some cases lipids (fatty) and carbohydrate material. Antibodies have no effect on viruses.

In spite of their danger in infecting humans, viruses are helpful in ecosystems where they destroy bacteria in oceans and facilitate recycling carbon. Viruses are the main agents responsible for the rapid destruction of harmful algae blooms, which algae blooms often kill other marine life. Certain viruses can kill targeted cancer cells in humans.

Certain exemplary embodiments break-up a structure of viruses. Viruses can be broken up via surface tension changes caused by glycerol and/or via osmosis caused by sodium chloride.

Surface tension describes a force exerted at an atomic level at a surface that comprises a liquid. At the surface, the liquid has a different environment outside of a virus than on an inside of the virus.

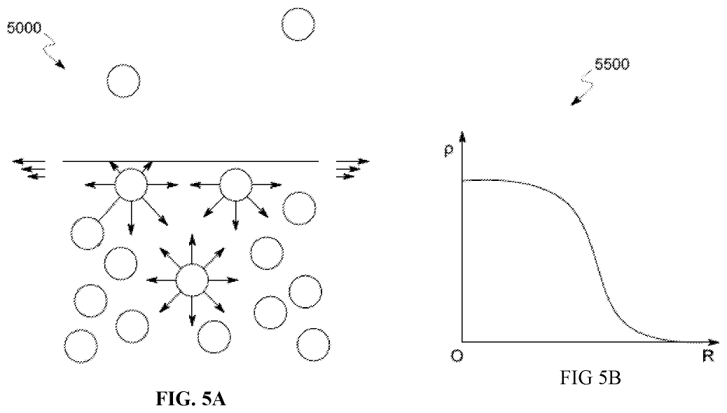

FIG. 5A is a set of diagrams 5000 of molecules at a surface of a fluid, which diagrams comprise:
(a) molecular forces experienced by a molecule in bulk, and at a fluid surface; and
(b) a density, ρ, as a function of distance R across the fluid surface.

As shown, a molecule in a bulk of a fluid experiences forces in all directions due to surrounding molecules. Molecules near a surface of the fluid will experience weaker force from the gaseous region above the surface than they would experience if the gaseous region was replace by fluid. The density of the gaseous region is considerably smaller than that of the bulk fluid. Consequently, such molecules will experience, on average, a force pulling them back into the bulk of the fluid as indicated in FIG. 5a. This force will have the effect of reducing the area of the surface providing the surface is free to change its shape as in the case of a water droplet, which takes a substantially spherical shape because the sphere has smaller surface area for a given volume than has any other geometric shape. The sphere will have a pressure difference of ΔP that may be present on opposite sides of the surfaces.

FIG. 5B is a diagram 5500 of density across a fluid surface. The force of surface tension will also reduce the density, ρ, of the fluid in the region of the surface as shown in FIG. 5b. Absent surface tension, fluid will evaporate.

There is an area comprised by a boundary pulling things apart. Three phases represented by a solid form as the mass of the virus, a liquid form represented by glycerol, and a gaseous form represented by air. Surface tension force will cause breaking of viral bonding, which eradicates the virus.

Since surface forces are localized within approximately one atomic or molecular thickness of the surface. Surface tension can be expressed as a force per unit length, a, in a membrane of negligible thickness at the surface of the fluid.

Surface tension can also be expanded between two liquids, called interfacial tension, and that between a solid (i.e., a virus) and a liquid (i.e., a glycerol solution), which can be called adhesion tension, which is responsible for debonding. There will also be a surface tension at a sold-gas interface.

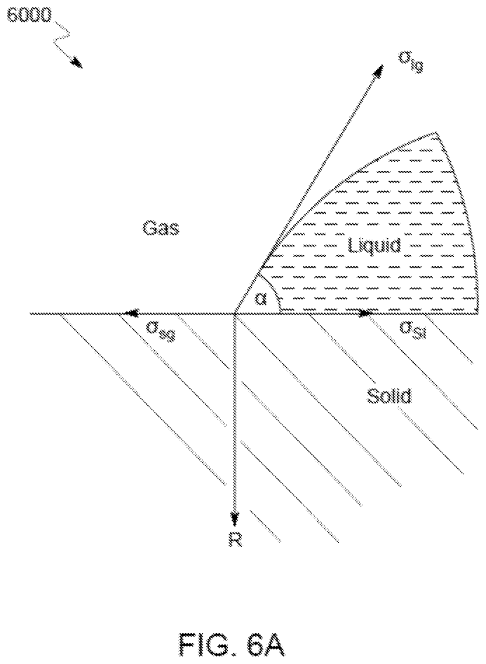

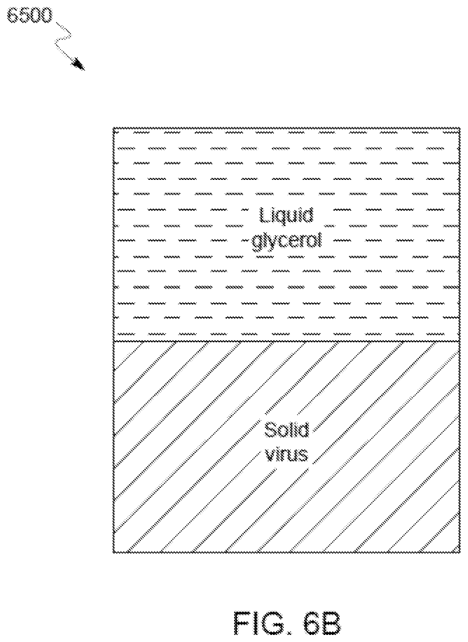

FIG. 6A is a diagram 6000 showing an angle of contact and surface tension for a solid-liquid-gas system. When a face mask is sprayed by the POWER SPRAY, there will always be intimate contact between glycerol molecules and any virus particles trapped in the mask. Such contact can be quantified by a Lennard-Jones potential equation, which can be used to model molecular interactions. Such an equation describes the dependence of potential energy when two molecules approach each other from a long distance apart. The energy is an interaction between molecules proportional to:

1/R⁶ (2)

and:

1/R¹² (3)

where: R=a distance between molecules.

The surface tension force at the contract between glycerol (liquid phase) and virus (solid phase) will be translated to an amount of pull between the interface in terms of mechanical work, which accompanies a distance, d, between two sides:

Work=force×distance (4)

In physics, work is defined as a force acting over a distance in a direction of motion (i.e., force and displacement are the elements of work). From equation (4), it is apparent that if the distance is zero, the work is zero, even if a force is applied. In other words, in physics, the concept of work is intimately tied in with motion. If there is no motion, there is no work performed.

FIG. 6B is a diagram 6500 of an interface between a virus and glycerol. In the case illustrated, movement exerted by the surface tension force breaks the virus apart. The reaction is governed by well established mathematical models:
Gibb's free energy;
Interactions described by the first law of thermodynamics; and/or
Interactions described by the Young-Laplace equation.

Gibb's free energy is expressed as:

ΔG=H−TΔS (5)

### Where:

H is the enthalpy of the system (i.e., the enthalpy of atomic bonding in virus structure);
T is the temperature;
S is system entropy (i.e., degree of disorder); and
G is system free energy.

For a reaction, a negative Gibbs free energy change value indicates that the reaction is favored and will occur spontaneously. As applied to viral destruction, the Gibbs free energy represents the energy available in the system. Viral destruction causes the molecular structure in greater disorder as debonding occurs.

The pull due to Gibbs Free Energy in an isothermal controlled system that comprises a glycerol-virus interface is further accentuated under the first law of thermodynamics. The first law of thermodynamics stands for a premise that the total energy in a closed system remains constant. When a system absorbs an amount of energy, Q, and performs an amount of work, W, the internal energy of the system changes by an amount ΔU, from an initial value of Uᵢ to a final value of U_{f} is described mathematically as follows:

ΔU=U_{f}−Uᵢ=Q±W (6)

This internal energy is changed from the atomic bonding structure of the virus.

Applying the Young-Laplace equation when virus structures cluster together, they enclose air or gas inside their enclosures or between them at a pressure greater than the external pressure. The free energy of the clusters will depend on their surface area and gas comprised inside. The equations states that in a spherical shape of a liquid drop, the excess pressure ΔP inside the liquid can be expressed in the following equation:

$$Δ P = \frac{4 σ}{R} \qquad ( 7 )$$

where: R is the radius of the spherical shape considered.

From the equation, it is apparent that small radii have large excess pressure compared to large radii. COVID-19 and other airborne viruses are known to have a spherical shape with a minute radius, which means that the differential pressure between inside and outside becomes relatively high. Accordingly, debonding and virus shape destruction is relatively favorable.

Osmosis is a process by which molecules of a solvent (e.g., water) tend to pass through a semipermeable membrane from a less concentrated solution into a more concentrated solution. The concentration gradient causes migration dissolved constituents in a more concentrated solution to a less concentrated solution in a process that seeks to equalize concentrations between solutions. Thus, a virus encapsulated by an outside membrane with fluid-containing materials inside, the solvent fluid will pass through the membrane to seek to equalize the equilibrium concentration of the sodium chloride from the POWER SPRAY on the face mask. The osmotic process renders virus cells in a flabby and weak situation due to their change in size and shape, which is part of the eradication mechanism.

The mechanism of osmosis and the usage of sodium chloride as an active ingredient has been used by mankind for millennia. Sodium chloride is edible in acceptable quantities and has been used in the preservation of food, mummification of bodies, and as a flavoring agent for food.

In certain exemplary embodiments, a user can enhance his or her immune system via one or more methods. The user can be directed to allocate a predetermined minimal amount of time for rest and/or sleep. A body temperature that is elevated above normal is an indication of something wrong with the user and/or the immune system of the user. When a virus invades a body of the user, there are usually immune responses from the body such that a battle ensues to combat the virus. The immune responses can be viewed as exothermic reactions. Chemical reaction rates increase as a temperature increases.

Arrhenius found that a certain amount of energy, called “activation energy” must be in a system in order for a reaction to progress. The higher the activation energy for a reaction, the higher a temperature must be to drive the reaction. Since higher temperatures provide more energy for a reaction, the rate of cell functions increases as temperatures increase and decreases as temperatures decrease.

As immune system fighting continues, more heat is generated. A human body can run through a vicious cycle and the outcome depends upon whether the immune system prevails in the battle. In order to assist the immune system in fighting, it is preferred to reduce a body temperature of the user. Applying cloth pads soaked with tap water on a forehead and/or limbs of the user on a continuous basis can assist in reducing body temperatures.

Certain exemplary embodiments utilize a thin perforated liquid crystal sheet integrated with a face mask, which acts as a safeguard to alert the user if his or her temperature is elevated above a predetermined threshold (e.g., 98.6 degrees Fahrenheit). The user can then take corrective action responsive to the alert. If an elevated temperature is detected, the user can apply cloth pads soaked with tap water on a forehead and/or limbs of the user on a continuous basis to assist in reducing body temperatures.

An equation that describes the reaction rate can be expressed as:

V=V₀E^{-0.0953T}
where: V₀ is the initial speed of a chemical reaction.

FIG. 7 is a flowchart of an exemplary embodiment of a method 7000. At activity 7100, a mask is fabricated. The mask comprises:
a liquid crystal sheet, the liquid crystal sheet constructed to detect a body temperature of a wearer of the face mask, the liquid crystal sheet constructed to alert the wearer if the body temperature if the wearer is above a predetermined threshold; and
a substantially square portion where the wearer sprays the face mask with the solution.

The substantially square portion can be approximately four square inches in size.

At activity 7200, certain exemplary embodiments cause a wearer to don a mask.

At activity 7300, certain exemplary embodiments cause a wearer to spray a mask. Certain exemplary embodiments cause a wearer to spray a face mask with a solution, the solution comprising glycerol and sodium chloride. The face mask can be sprayed with approximately three ounces of the solution, in an intermittent periods of time, to last for approximately one week.

At activity 7400, certain exemplary embodiments cause a wearer to remove a mask.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
add—to include something in a system.
alert—(n) an electrical, electronic, or mechanical device and/or display that serves to advise of a condition by means of a sound or signal; (v) to provide an indication that makes someone aware of something (e.g., a body temperature).
and/or—either in conjunction with or in alternative to.
anhydrous—free from water.
apparatus—an appliance or device for a particular purpose.
associate—to join, connect together, and/or relate.
body—a physical form of a human.
can—is capable of, in at least some embodiments.
cause—to bring about.
change—to make different.
color—a characteristic of human visual perception described through color categories, with names such as red, yellow, purple, or blue.
comprising—including but not limited to.
configure—to make suitable or fit for a specific use or situation.
connect—to join or fasten together.
constructed to—made to and/or designed to.
convert—to transform, adapt, and/or change.
couple—to physically join in some fashion.
coupleable—capable of being joined, connected, and/or linked together.
define—to establish the outline, form, or structure of.
detect—to sense or perceive.
determine—to obtain, calculate, decide, deduce, and/or ascertain.
device—a machine, manufacture, and/or collection thereof.
edible—something that is suitable or safe for a human to eat.
estimate—to calculate and/or determine approximately and/or tentatively.
face—the front part of the head that in humans extends from the forehead to the chin and includes the mouth, nose, cheeks, and eyes.
face mask—a protective covering for the nose and mouth or nose and eyes of a wearer.
generate—to create, produce, give rise to, and/or bring into existence.
glycerol—a syrupy hygroscopic trihydroxy alcohol C₃H₈O₃.
install—to connect or set in position and prepare for use.
liquid crystal—a state of matter in a solid phase in which the molecular polymer possesses orientation order when subjected to one or more specific temperatures and, thus, changes in color when subjected to the one or more specific temperatures.
may—is allowed and/or permitted to, in at least some embodiments.
method—a process, procedure, and/or collection of related activities for accomplishing something.
plurality—the state of being plural and/or more than one.
portion—a part of a whole.
predetermined—established in advance.
product—something that is made or grown to be sold or used.
provide—to furnish, supply, give, and/or make available.
receive—to get, take, acquire, and/or obtain.
repeatedly—again and again; repetitively.
request—to express a desire for and/or ask for.
set—a related plurality.
sheet—a substantially planar layer of something.
sodium chloride—an ionic crystalline chemical compound consisting of equal numbers of sodium and chlorine atoms.
solution—a substantially homogeneous mixture comprising of two or more substances. The solution comprises a solvent and a solute; the solute is a substance dissolved in the solvent.
spray—to cause a jet of vapor or finely divided liquid to be dispersed in a space.
square—having at least one cross-section shaped as a rectangle with all four sides having a substantially equal length.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
temperature—a measure of kinetic energy of a substance.
threshold—a point that when exceeded produces a given effect or result.
transmit—to send, provide, furnish, and/or supply.
user—any person that uses a device and/or service.
via—by way of and/or utilizing.
wearer—a human that dons something.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A face mask comprising:
a liquid crystal sheet, the liquid crystal sheet constructed to detect a body temperature of a wearer of the face mask, the liquid crystal sheet constructed to alert the wearer if the body temperature if the wearer is above a predetermined threshold; and
a portion constructed to receive a solution, the solution comprising glycerol and sodium chloride.

2. The face mask of claim 1, wherein:
the liquid crystal sheet changes color responsive to a change of the body temperature of the wearer.

3. The face mask of claim 1, wherein:
the solution comprises approximately 80 percent vegetable glycerol solution prepared from a substantially anhydrous product.

4. The face mask of claim 1, wherein:
the solution comprises approximately 20 grams of edible sodium chloride are added per 100 milliliters of the solution.

5. A method comprising:
causing a wearer to spray a face mask with a solution, the solution comprising glycerol and sodium chloride, the face mask comprising;
a liquid crystal sheet, the liquid crystal sheet constructed to detect a body temperature of the wearer of the face mask, the liquid crystal sheet constructed to alert the wearer if the body temperature if the wearer is above a predetermined threshold; and
a substantially square portion where the wearer sprays the face mask with the solution.

6. The method of claim 5, wherein:
the substantially square portion is approximately four square inches in size.

7. The method of claim 5, wherein:
the face mask is sprayed with approximately three ounces of the solution, in an intermittent periods of time, to last for approximately one week.
